(19) United States
(12) Patent Application Publication
(10) Pub. No.: US 2011/0104350 A1
(43) Pub. Date: May 5, 2011

(54) METHOD AND DEVICE FOR HEAT-TREATING LIQUID FOODS

(76) Inventors: Ludwig Clüsserath, Bad Kreuznach (DE); Bernd Bruch, Weinsheim (DE)

(21) Appl. No.: 12/996,289

(22) PCT Filed: Jul. 10, 2009
(86) PCT No.: PCT/EP09/05000

§ 371 Date: Dec. 3, 2010

(30) Foreign Application Priority Data
Aug. 14, 2008 (DE) 10-2008-037726.0

(51) Int. Cl. A47J 36/00; A23L 2/46; A23L 2/02

(52) U.S. Cl. 426/519; 99/348

(57) ABSTRACT

The invention relates to a method and a device for heat-treating and/or cooling liquid foods, in particular drinks. According to the invention, the liquid food is heated by at least one heat transfer medium during heat exchange and the foods and/or the heat transfer medium is guided along a spiral- and/or helical-shaped fluid channel (1; 2, 3).

The invention relates to a method for heat-treating liquid foodstuffs, in particular beverages, preferably fruit juices or similar highly viscous liquids with or without solids content, according to which method the liquid foodstuffs are heated by means of at least one heat carrying medium in the course of a heat exchange.

Heat-treating liquid foodstuffs is particularly important so as to guarantee storage life and enjoyment. In the course of such heat treatment, also called pasteurizing or pasteurization, the relevant liquid foodstuffs are heated in the short-term to ca. 60° C. to 90° C., in certain cases even up to 140° C., so as to kill off any micro organisms. In this case, corresponding to the findings of the French chemist Louis Pasteur, it also involves storing the heat-treated substances or foodstuffs in a sealed container or in a closed region, for this is the only way to be able to guarantee that new micro organisms are not able to penetrate once any that may have been present initially have been killed off.

Along with the known pasteurizing of milk, other liquid foodstuffs, such as wine, fruit juice or beer, are also subject to the described heat treatment or pasteurization. Heat exchangers are used in practice, among other things, for this purpose, said heat exchangers being in the form of tubular heat exchangers corresponding to generic DE 297 24 324 U1. In reality, a plurality of inside pipes are situated, in this case, in a cylindrical heat exchanger and the liquid foodstuffs to be heat-treated are guided through said inside pipes. In contrast, the heat carrying medium traverses the outside pipe or the space remaining between the individual inside pipes.

The known method of operation has been proven in principle, but requires a good deal of space as regards the necessary heat exchanging surfaces. To this must be added that the tubular heat exchanger or such a heat exchanger with bundles of pipes can cause problems when highly viscous beverages such as, for example, fruit juices are to be heat-treated. This is due to the fact that, as a rule, the bundles of pipes have a more or less strong change in direction at the input and/or output of an associated heat exchanger. Solids such a fruit fibres, present for example in fruit juices, can get caught in said one or in the many direction changes. As a result of this, deposits build up and in the worst case scenario lead or can lead to blockages in the heat exchanger.

In addition solids entrained in the foodstuffs frequently form coverings in the interior of the heat exchanger, which, in the case of a jagged design with sharp changes in direction, can only be removed with difficulty or cannot be removed at all. In this case too, impairments in the operation of the heat exchanger and/or a reduction in its efficiency due to the coverings deposited are possible and are observed in practice.

The same is true for a device for heat-treating milk, such as is described in DE 30 40 943 C2. A plate heat exchanger is used in this case and the heat exchange takes place in the counter flow. However, no approaches promising success in solving the problems outlined above can be deduced from said document.

The technical problem underlying the invention is to develop further a method for heat-treating liquid foodstuffs of the aforementioned development such that a liquid flow with as little resistance as possible with no strong direction changes and with as homogeneous a velocity profile as possible is made available in order to prevent deposits, with the heat exchanger being designed in a compact, space-saving manner at the same time. A particularly suitable device is also to be provided.

To solve this technical problem, a generic method within the framework of the invention is characterized in that the foodstuffs to be heat-treated and/or the heat carrying medium are guided along a spiral and/or helical liquid channel.

The liquid channel for the foodstuffs is also identified as the foodstuffs liquid channel. The heat carrying medium is guided along a heat carrying medium liquid channel. According to the invention, at least one of said two liquid channels or both liquid channels are designed in each case in a spiral and/or helical manner. This means that in the case of a spiral embodiment, the respective liquid channel describes a curve that extends about a central point or an axis of the mostly cylindrical heat exchanger, and depending on the direction of travel gets further and further away from the axis or nearer and nearer to it. Normally such a spiral, and consequently the respective liquid channel, extends in one plane, but can also have a spatial dimension. The so-called Archimedes' spiral must be mentioned at this point, describing a spiral that gets further away from the axis or its central point along a spherical surface or gets nearer to it.

Generally speaking and for reasons of a particularly compact design, the at least one liquid channel or both liquid channels are guided in a helical manner. This means that the respective liquid channel describes a curve that winds around the outer surface of a cylinder at a constant inclination. In this respect, such a helical course of the liquid channel is particularly suitable when an overall cylindrical heat exchanger is used. Said heat exchanger can be designed in cross section from one or more pipe rings, it being possible to place the respective liquid channel in the interior of such a pipe ring. In so far as, in this connection, the liquid channel is connected to an inside surface and/or outside surface of the pipe ring so as to be liquid-tight, two helical liquid channels extending parallel to each other are defined practically automatically, said liquid channels being in thermal contact over their entire length and as a result making a particularly large heat exchanging surface available. Obviously it is also possible for the respective liquid channel to have a combined spiral and helical structure. As a rule, however, this is designed so as to be continuously helical with the inclination remaining the same as described.

Within the framework of the invention, it is not only possible to subject the liquid foodstuffs to be heat-treated to a heat treatment or pasteurization in a direct manner with the assistance of the heat carrying medium, it is also possible to carry out this operation in an indirect manner. This refers, within the framework of the invention, to the method of operation where the heat is first of all transferred from a heat carrying medium to a transfer medium and then from said transfer medium to the foodstuffs. This design makes it possible to separate the liquid channels of, on the one side, the foodstuffs and, on the other side, the heat carrying medium from each other in a localized manner over their entire length by the liquid channel of the transfer medium. This guarantees that even in the case of a possible leak from the liquid channel for the foodstuffs, the foodstuffs will not be recontaminated by the heat carrying medium. For direct contact—as described—is prevented by the interposed transfer medium. In this case, the transfer medium can be designed such that it is guided in a completely autonomous, closed liquid channel in the interior of the heat exchanger and as a result is closed off from the external environment. This means that the entry of microbes can be successfully prevented, even if the foodstuffs liquid channel were to leak.

Water or also the previously heated foodstuffs may act as the heat carrying medium so as to keep the energy losses as low as possible. Obviously other liquids or even gases are also possible as the heat carrying medium and are included by the invention.

It is seen as particularly successful when the respective liquid channel has a cross sectional rectangular profile with, where applicable, rounded corners. If such a helical liquid channel produced from the described rectangular hollow profile is placed in the interior of the pipe ring, it is possible to realize a particularly large heat exchanging surface in the smallest space. For in this case, the liquid foodstuffs can be guided through the relevant helical liquid channel that is provided with the cross sectional rectangular profile, whereas the heat carrying medium flows through the pipe ring, for example in the axial direction. The procedure can obviously also be reversed. In this case, the liquid foodstuffs to be heat-treated are guided through the pipe ring, whereas the helical liquid channel accommodates the heat carrying medium.

If the liquid channel with the cross sectional rectangular profile fills out the pipe ring between its inside surface and its outside surface, an additional, equally helical liquid channel with the same inclination is defined in the intermediate spaces between the individual helices, both liquid channels extending parallel to each other. This provides particularly deep thermal contact. For in the case of this variant, all the liquid channels of the media participating in the heat transfer are guided in a helical manner through the pipe ring or the heat exchanger.

In order to increase the participating surfaces and to ensure optimization of the flow profiles, it has also proven favourable for the respective liquid channel to be provided on the outside wall and/or inside wall with flow resistances for turbulence generation, said resistances extending substantially transversely relative to the flow. The flow resistances, in this case, are routinely situated on the wide faces of the cross sectional rectangular profile because the liquid channel is connected in a liquid-tight manner to the inside surface or outside surface of the pipe ring by way of one or by way of the two narrow faces. This can be ensured in the course of laser welding or also in another manner.

In order to be able to produce the liquid channel with a cross sectional rectangular profile and helical shape, it has been shown to be helpful, generally speaking, to produce a rectangular profile by means of so-called hydroforming from correspondingly developed pipes. In the course of the hydroforming or internal high pressure forming, a tubular workpiece is widened through internal pressure and at the same time is compressed by an axial force.

Cylindrical pipes, for example, can be worked with in this case, obtaining the desired shape with the cross sectional rectangular profile by means of internal pressure. As the internal high pressure forming takes place in the majority of cases in a closed tool, not only is it possible for the cross-sectional rectangular profile to be stamped to form the pipe section to be treated, but the pipe section can also be provided with the necessary helical shape in the tool at the same time. This means that it is conceivable to produce individual helical segments with a cross sectional rectangular profile from cylindrical pipes by means of internal high pressure forming. Said helical segments may describe an angular region of up to 360° C. for example.

A plurality of such helical segments can be subsequently interconnected (for example by means of welding) and can provide the desired helical liquid channel. In addition, the described internal high pressure forming is able to ensure automatically and in one operating step that the pipes or pipe sections, as raw materials, not only have the desired helical shape with the cross sectional rectangular profile but at the same time are provided with the flow resistances that extend transversely relative to the flow. In reality, said flow resistances can be defined as ribbing or stampings and are provided on the wide faces of the rectangle. In this case the flow resistances may be oriented in each case in the radial direction in comparison to the axis of the helix. The axis of the helix or the helical axis normally coincides with the axis of the cylindrical heat exchanger, that is the cylinder axis.

As a result, a method and a device for heat-treating liquid foodstuffs are put forward, distinguished by a compact design and a particularly flow-enhancing development within the liquid channels. This can be traced back to the fact that kinks, sharp bends, etc can be avoided through the helical character of the at least one liquid channel. As a result of this, the device, and also the method, is particularly suitable for heat-treating highly viscous liquids or highly viscous liquid foodstuffs. Highly viscous foodstuffs in terms of the invention refer to those foodstuffs that clearly have a higher viscosity than water, for example. Often such liquid foodstuffs have a not inconsiderable solids content, which is characterized by fruit constituents, fruit fibres, etc, which arise inevitably during the preparation of the foodstuffs.

As increasingly such solids content or fruit fibres are required by consumers in the relevant liquid foodstuffs and are seen as a particular quality feature, more and more significance is given to the treatment of such highly viscous liquids and in particular to their pasteurization. The invention has recognized this and for the first time makes a device and a method for heat-treating such liquids available, ensuring low maintenance and almost fault-free operation. For blockages, deposits, etc are not to be expected due to the fact that the liquid is guided in a flow-enhancing manner. All this is achieved over and above a particularly compact design which means that the production costs for a correspondingly developed heat exchanger are low. All the more as the liquid channel developed in a helical manner in each case can be produced completely or segmentally in practice in one single operating step by means of internal high pressure forming.

The object of the invention is also the application of a heat exchanger with at least one liquid channel for the liquid to be heated and one liquid channel for a heat carrying medium, at least one of the two liquid channels being realized in a spiral and/or helical manner. Such a heat exchanger with at least one helical liquid channel is known in principle in DE 10 2006 019 844 A1, however in conjunction with a heating device. Consequently the application according to the invention according to applicable Claim 14 is aimed at the use of such a heat exchanger for heat-treating and in particular pasteurizing beverages, or liquid foodstuffs. It is especially concerned with heat-treating highly viscous liquid foodstuffs with or without solids content. This is where the essential advantages are to be seen.

The invention is described below by way of a drawing representing just one exemplary embodiment, in which, in detail:

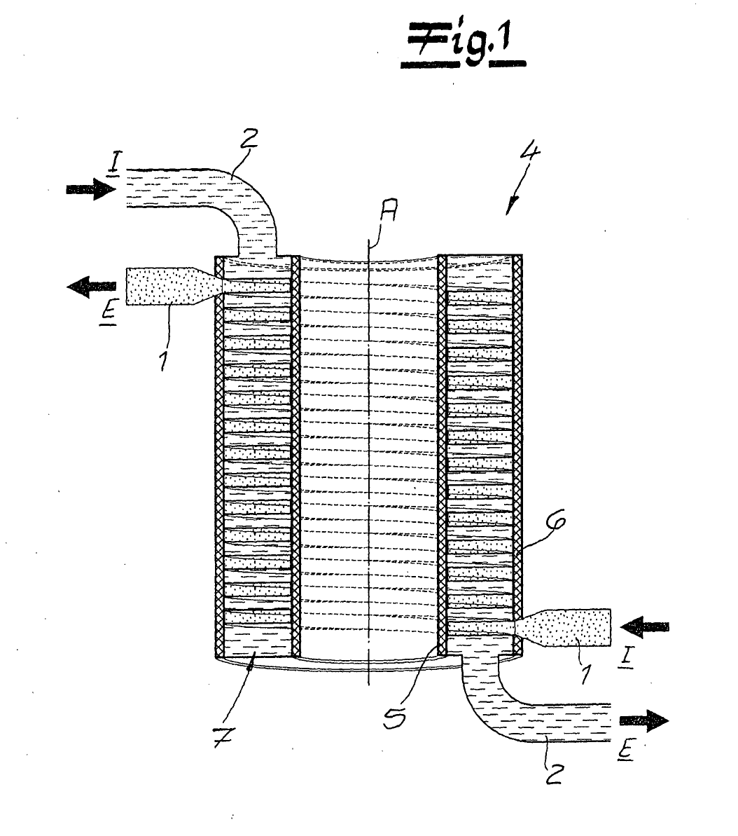

FIG. 1 shows a schematic representation of a device according to the invention for heat-treating,

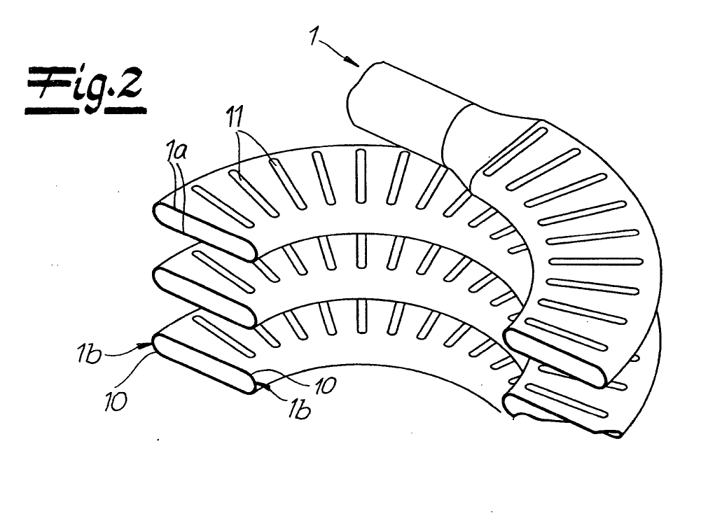

FIG. 2 shows a detail from FIG. 1, namely the helical liquid channel,

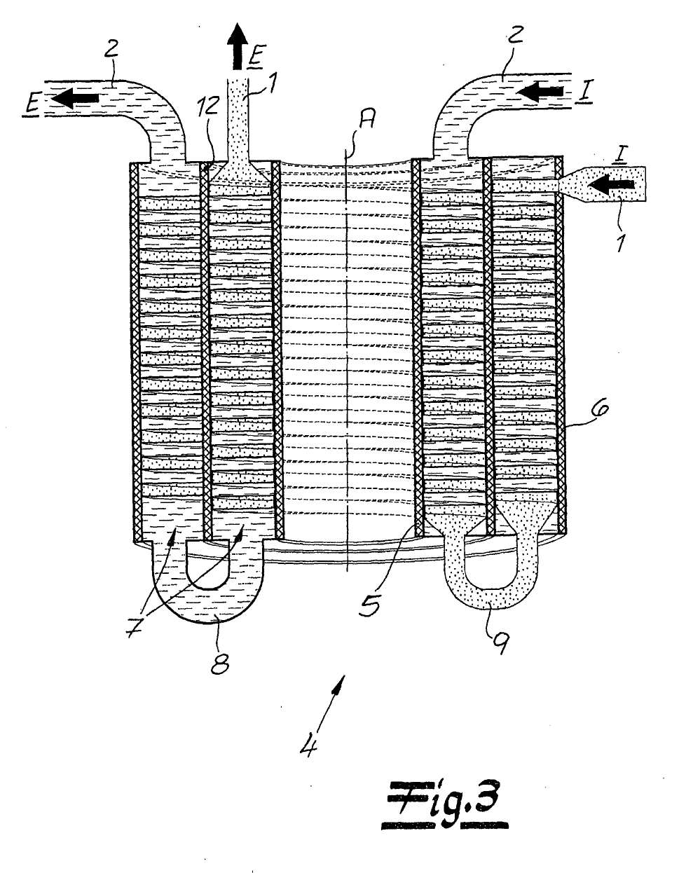

FIG. 3 shows a modified embodiment of the invention and

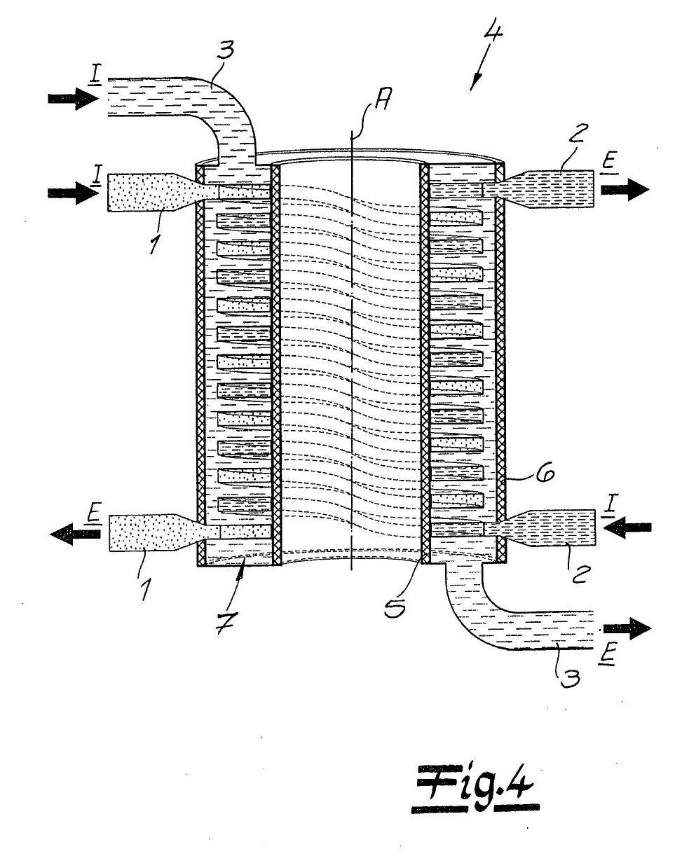

FIG. 4 shows another variant of the invention with an additional transfer medium liquid channel.

A device for heat treatment is shown in the Figures. Said device, in its basic design, has a foodstuffs liquid channel 1 and at least one heat carrying liquid channel 2, which are in direct or indirect thermal contact with each other. Within the framework of the variant in FIG. 2, a direct heat exchange takes place between the foodstuffs liquid channel 1 and the heat carrying medium liquid channel 2. Contrary to this, FIG. 4 represents a variant where the heat from the heat carrying medium liquid channel 2 is transferred indirectly to the foodstuffs liquid channel 1, namely by interposing a transfer medium liquid channel 3.

The liquid channels 1, 2 or 1, 2, 3 together form a heat exchanger 4 or are accommodated in such a heat exchanger 4. Said heat exchanger 4 represents the heart or core of the device for heat-treating that is shown.

According to the invention, it is provided that the foodstuffs liquid channel 1 and/or the heat carrying medium liquid channel 2 are realized at least in the region of their common heat exchanger 4 in a spiral or helical manner. Within the framework of the representation in FIG. 1, the foodstuffs liquid channel 1 has a helical shape. This means that the foodstuffs liquid channel 1 describes in space a curve that winds at a constant inclination about the outer surface of a cylinder 5, 6 or at identical spacing in comparison to a helix axis A. The helical axis A at the same time represents the cylinder axis A of the relevant cylinder 5, 6. The cylinder 5, 6 has an inside surface 5 and an outside surface 6, which between them define a pipe ring 7.

Two pipe rings 7, which are located concentrically, abut against each other in relation to the common axis A and are coupled together in each case by means of a connecting line 8, are realized within the framework of the variant in FIG. 3. In this conjunction, the job of the connecting line 8 is to guide the heat carrying medium through the two pipe rings 7 from one inlet I as far as to the outlet E. The same thing applies to the connecting line 9, which ensures the same for the liquid foodstuffs and consequently for the foodstuffs liquid channel 1. It can be seen that the two pipe rings 7 are separated from each other by a partition wall 12. The partition wall 12 represents the outside surface 6 for the radially innermost pipe ring 7 and at the same time the inside surface 5 for the radially outer pipe ring 7.

Within the framework of all the representations, the foodstuffs liquid channel 1 is developed in a helix in such a manner as is shown in detail in FIG. 2. The same applies to the heat transfer medium liquid channel 2 in the variant in FIG. 4. In said representation it can be seen that the respective liquid channel 1 has a cross sectional rectangular profile in the case in example. Said cross sectional rectangular profile is composed by two wide faces 1a and two narrow faces 1b. Over and above this, the foodstuffs liquid channel or its cross sectional rectangular profile has rounded corners 10. Said rounded corners are produced automatically due to the fact that said liquid channel is produced from a pipe piece by means of internal high pressure forming.

The foodstuffs liquid channel 1 is wound about an inner pipe core of the pipe ring 7, more precisely about the cylindrical inside surface 5. On the outside, the foodstuffs liquid channel 1 is closed off by the equally cylindrical outside surface 6. If the helical foodstuffs liquid channel 1 is connected in a liquid-tight manner (for example by means of laser welding) by way of its two narrow faces 1b on one side to the inside surface 5 and on the other side to the outside surface 6, a second helical liquid channel 2 is automatically formed in the pipe ring 7, namely the heat carrying medium liquid channel 2 (cf. FIGS. 1 and 3). This is obviously not compulsory. For, in the case in example, the foodstuffs liquid channel 1 can also be placed freely and with no direct contact in the pipe ring 7 between the inside surface 5 and the outside surface 6. Even a one-sided connection via a narrow face 1b to either the inside surface 5 or the outside surface 6 is conceivable and is included by the invention, such as accounted for by the variant in FIG. 4, which shows both a helical foodstuffs liquid channel 1 and a heat carrying medium liquid channel 2, which are only connected to the pipe ring 7 on one side (namely to its inside surface 5).

Within the framework of all these cases, the heat carrying medium, along its heat carrying medium liquid channel 2, traverses the pipe ring 7 or the cylindrical heat exchanger 4 more or less transversely relative to the direction of flow of the liquid foodstuffs or in the counter flow. If the foodstuffs liquid channel 1 is connected to both the inside surface 5 and the outside surface 6, the heat carrying medium is also guided in a helical manner through the heat carrying medium liquid channel 2, parallel to the helical guiding of the liquid foodstuffs. In each case, the heat exchanger 4 is traversed in the counter flow.

By way of a detailed representation in FIG. 2, it can be seen over and above this that the helical liquid channel, the foodstuffs liquid channel 1 in the exemplary embodiment, is provided on the outside wall and/or on the inside wall with flow resistances for generating turbulence, said flow resistances extending substantially transversely relative to the flow. Said flow resistances may be indented beading, ribbing or comparable stampings, which, through their position transversely relative to the direction of flow, bring about turbulence in the medium guided in the interior, here the liquid foodstuffs. It can be seen that the flow resistances 11 in the exemplary embodiment are located in each case radially in comparison to the helix axis A or cylinder axis A. This not only increases the generation of turbulence and consequently also the thermal transfer, but also the compressive strength of the helical liquid channel 1.

Within the framework of the variant in FIG. 4, on the one side the foodstuffs liquid channel 1 and on the other side the heat carrying medium liquid channel 2 are separated from each other in a localized manner over their entire length by the interposed transfer medium liquid channel 3. This ensures that even if there is a leak in the foodstuffs liquid channel 1, recontamination through, for example, microbes located in the heat carrying medium, is prevented as the transfer medium, which is guided or can be guided in a closed circuit through the transfer medium liquid channel 3, is interposed at this point.

Either way the selected helical shape for at least liquid channel 1 in the case in example determines that a large heat exchanging surface is combined at the same time with a compact overall design. In this case, the respective layout of the liquid channels 1, 2, 3 plays practically no role in the invention. This means that the foodstuffs liquid channel 1 and also the heat carrying medium liquid channel 2 can equally exchange their roles just as the transfer medium liquid channel 3 and the foodstuffs liquid channel 1 or heat carrying medium liquid channel 2. This means that the guiding of the individual media is actually only to be understood as an example and is no way restricting.

It has been assumed above that the present invention is to be used exclusively for heating a product to be pasteurized. The present invention is obviously also suitable to cool the ready-pasteurized product.

In addition, the ready-pasteurized product can also assume the function of the heat carrying medium, for example to preheat or heat up new products that have not yet been pasteurized, it being cooled down itself.

1. A method for heat treating and/or cooling liquid foodstuffs, said method comprising:
heating or cooling the liquid foodstuffs using at least one heat carrying medium, and
in the course of heat exchange, guiding at least one of the liquid foodstuffs and the heat carrying medium along a spiral and/or helical liquid channel.

2. The method of claim 1, wherein heating or cooling foodstuffs comprises indirectly heating or cooling using an interposed transfer medium.

3. The method of claim 2, further comprising separating liquid channels of, on the one side, the foodstuffs and, on the other side, of the heat carrying medium from one another in a localized manner over their entire length by a liquid channel of the transfer medium.

4. A device for heat-treating liquid foodstuffs, said device including:
a foodstuffs liquid channel, and
at least one heat carrying medium liquid channel in thermal contact with the foodstuffs liquid channel,
wherein, at least in a region of a common heat exchanger, at least one of the foodstuffs liquid channel and the heat carrying medium liquid channel is realized in a spiral or helical manner.

5. The device of claim 4, further comprising:
a transfer medium liquid channel in thermal contact, on a first side, with the heat carrying medium liquid channel and, on a second side, with the foodstuffs liquid channel.

6. The device of claim 4, further comprising:
a transfer medium liquid channel interposed between the foodstuffs liquid channel and the heat carrying liquid channel for separating the foodstuffs liquid channel and the heat carrying liquid channel from each other in a localized manner over their entire length within the heat exchanger.

7. The device of claim 4, wherein at least one liquid channel has a cross sectional rectangular profile.

8. The device of claim 4, wherein at least one liquid channel comprises, on a wall thereof, flow resistances for generating turbulence, said flow resistances extending substantially transversely relative to flow.

9. The device of claim 4, wherein the heat exchanger is designed in cross section from one or more pipe rings.

10. The device of claim 4, wherein at least one liquid channel is placed in an interior of a pipe ring.

11. The device of claim 4, wherein at least one liquid channel is connected to an inside surface and/or an outside surface of a pipe ring so as to be liquid-tight.

12. The device of claim 4, wherein the liquid channel is produced by means of an internal high pressure forming operation.

13. A method comprising changing heat content of a liquid foodstuff using a heat exchanger having
at least one liquid channel for the liquid foodstuff, and
at least one liquid channel for a heat carrying medium,
at least one of the two liquid channels being realized in a spiral and/or helical manner.

14. The device of claim 4, wherein the liquid channels are located in the interior of the heat exchanger.

15. The method of claim 1, further comprising selecting the liquid foodstuff to be a fruit juice.

16. The device according to claim 5, wherein at least one liquid channel has a cross sectional rectangular profile.

17. The device according to claim 4, wherein at least one liquid channel has a cross sectional profile with a rounded corner.

18. The device according to claim 5, wherein at least one liquid channel has a cross sectional profile with a rounded corner.

19. The device according to claim 9, wherein the heat exchanger is cylindrical on an outside thereof.
